(19) United States
(12) Patent Application Publication
(10) Pub. No.: US 2013/0064402 A1
(43) Pub. Date: Mar. 14, 2013

(54) Sound Systems

(71) Applicant: Alex Sandaire, Bayonne, NJ (US)

(72) Inventor: Alex Sandaire, Bayonne, NJ (US)

(21) Appl. No.: 13/305,440

(22) Filed: Nov. 28, 2011

Related U.S. Application Data
(60) Provisional application No. 61/534,703, filed on Sep. 14, 2011.

(51) Int. Cl. H04R 5/02

(52) U.S. Cl. 381/300

(57) ABSTRACT

According to certain embodiments of the present disclosure, systems are disclosed that house and orient electro-acoustic drivers therein to simulate surround effects from a single enclosure.

### CLAIM OF PRIORITY

This application claims priority to provisional application No. 61/534,703 titled “Sound System” filed on Sep. 14, 2011 which is incorporated by reference herein in its entirety.

### BACKGROUND/FIELD

Within the field of sound reproduction, it is known that control of reflecting versus direct channels of sound can be manipulated in order to achieve a simulated surround sound effect.

Consequently, systems are disclosed that house and orient electro-acoustic drivers therein to simulate surround effects from a single enclosure.

### SUMMARY

According to an embodiment of the present disclosure, a sound system for use in an enclosed room is described having a listening position disposed therein comprising; an electro-acoustic driver mounted upon a first surface A, wherein ray X, extending in an orthogonal relation from the face of A can reach the listening position without substantial interference from a wall, floor, or ceiling thereby defining a direct configuration; an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling thereby defining a reflecting configuration.

According to further embodiments of the present disclosure, a sound system further comprises drivers that are full range drivers.

According to further embodiments of the present disclosure, a sound system further comprises a system wherein each driver is arranged in a woofer and tweeter configuration.

According to further embodiments of the present disclosure, a sound system further comprises a system wherein the exits of both the tweeter and woofer are disposed substantially within the waveguide.

According to further embodiments of the present disclosure, a sound system further comprises a system wherein the exit of the high frequency driver is disposed substantially within the waveguide.

According to further embodiments of the present disclosure, a sound system further comprises a system wherein there is a plurality of drivers disposed within the enclosure and divided into two sets, with the first set configured in a direct configuration, and a second set configured in a reflecting configuration.

According to further embodiments of the present disclosure, a sound system further comprises a system wherein first set comprises a left-facing driver disposed at a lateral angle θ1 from the saggital plane, a center-facing driver in substantial alignment with the saggital plane, and a right-facing driver disposed at a lateral angle—θ1 from the saggital plane therein θ1 is between 4 and 40 degrees.

According to further embodiments of the present disclosure, a sound system further comprises a system wherein the second set comprises a left-facing speaker disposed at a lateral angle θ2 from the saggital plane and a cephalic angle θ3 from the traverse plane and right-facing speaker at a lateral angle—θ2 from the saggital plane and a cephalic angle θ3 from the traverse plane wherein θ2 and θ3 are each between 15 and 85 degrees.

According to further embodiments of the present disclosure, a sound system further comprises a system wherein there is a low frequency driver and enclosure disposed caudally from the direct and reflecting drivers.

According to further embodiments of the present disclosure, a sound system further comprises a system wherein the low frequency driver is enclosed in a box having a configuration selected from ported, sealed, bass trap, or transmission line and tune to a frequency between 20 Hz and 600 Hz.

According to further embodiments of the present disclosure, a sound system further comprises a system wherein the wave-guide is a constant-directivity horn.

According to further embodiments of the present disclosure, a sound system further comprises a system wherein the wave-guide is oblate sphericoid in shape.

According to further embodiments of the present disclosure, a sound system further comprises a system wherein the wave-guide is a circular horn tuned predominantly to a frequency between 100 Hz and 20,000 Hz.

According to further embodiments of the present disclosure, a sound system further comprises a system wherein the, wave-guide is an elliptical horn tuned predominantly to a frequency between 100 Hz and 20,000 Hz.

According to further embodiments of the present disclosure, a sound system further comprises a system wherein the wave-guide is an angular horn tuned predominantly to a frequency between 100 Hz and 20,000 Hz.

According to further embodiments of the present disclosure, a sound system further comprises a system wherein the wave-guide encloses the entire circumference of its corresponding driver.

According to further embodiments of the present disclosure, a sound system further comprises a system wherein the wave-guide encloses a portion of the circumference of its corresponding driver.

According to an embodiment of the present disclosure, a sound system for use in an enclosed room is described having a listening position disposed therein comprising; an electro-acoustic driver mounted upon a first surface A, wherein ray X, extending in an orthogonal relation from the face of A can reach the listening position without substantial interference from a wall, floor, or ceiling; an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling; wherein the drivers are full range speakers and the waveguide is a horn tuned to a frequency between 100 Hz and 20,000 Hz.

According to an embodiment of the present disclosure, a sound system for use in an enclosed room is described having a listening position disposed therein comprising; an electro-acoustic driver mounted upon a first surface A, wherein ray X, extending in an orthogonal relation from the face of A can reach the listening position without substantial interference from a wall, floor, or ceiling; an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows a perspective view of an embodiment of a sound system.

FIG. 2 shows a perspective through-view of a bass section of the sound system of FIG. 1.

FIG. 3 shows a perspective through-view of a direct and reflecting section of the sound system of FIG. 1.

FIG. 4 shows a ray diagram of the reflection patterns of the sound system of FIG. 1 as used in a room.

### DETAILED DESCRIPTION OF THE FIGURES

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similar, anatomical terms of reference such as dorsal, lateral, anterior, and sagittal shall have their accepted meanings in the arts.

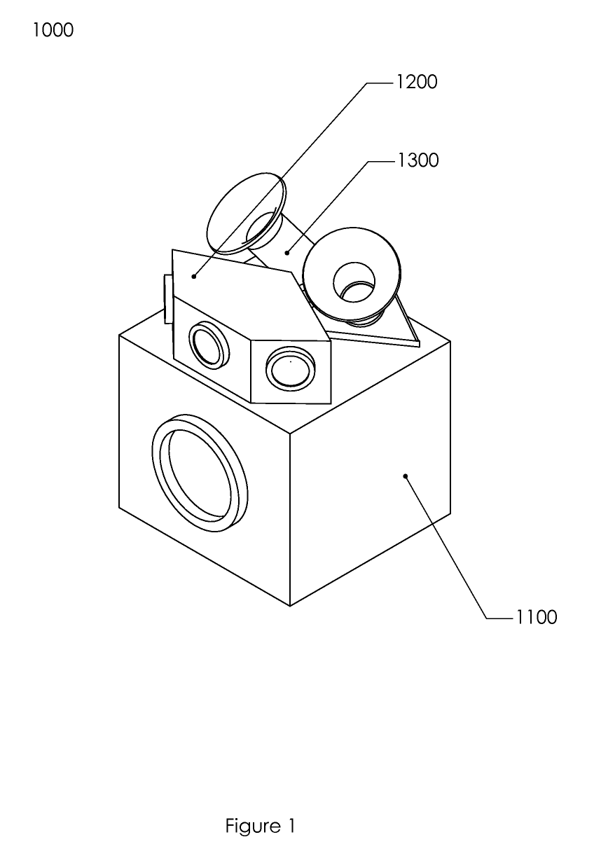

According to a first embodiment of the present disclosure shown in FIG. 1, a sound system 1000 comprises a bass section 1100, a direct section 1200, and a reflecting section 1300.

The embodiments of the present disclosure within the scope of the appended claim in general and sound system 1000 in particular are capable of producing both direct and reflected sound from a single speaker enclosure. Within this document direct sound shall mean sound the majority of which reaches a listener without having bounced off of a wall, ceiling, floor, or other structure. Within this document, reflected sound shall mean sound the majority of which reaches a listener after having bounced off of a wall, ceiling, floor, or other structure. Controlling direct versus reflected sound is useful in simulating ‘surround’ acoustic effects.

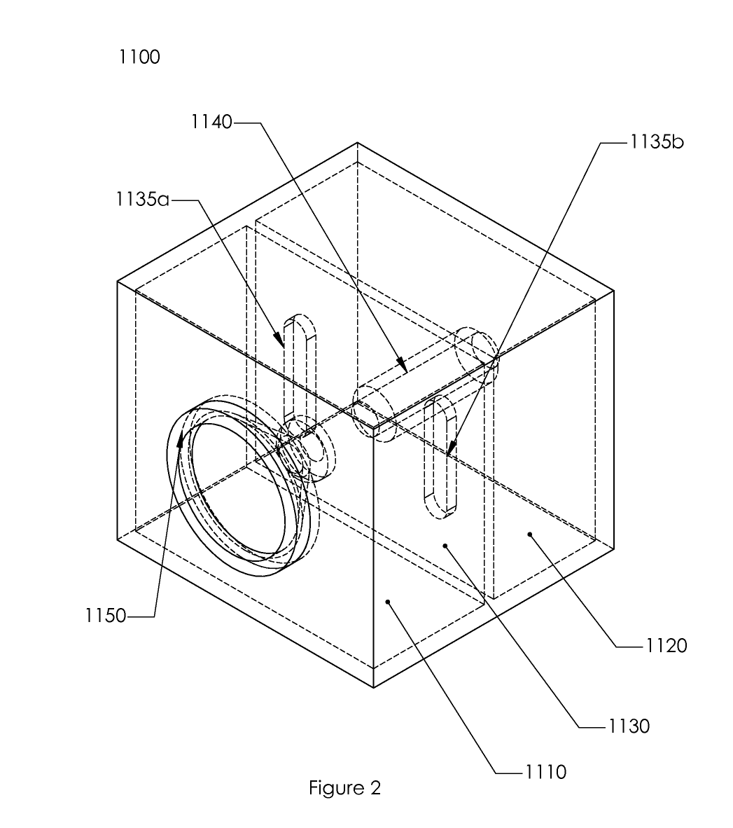

Referring now to FIG. 2, a bass section 1100 comprises an anterior volume 1110 and a posterior volume 1120 wherein the volumes are separated by a dividing wall 1130. Wall 1130 has apertures 1135(a and b) removed from opposing sides thereof with a tubular vent 1140 connecting anterior volume 1110 to the space outside of bass section 1100. There is an electromagnetic driver 1150 disposed upon the anterior face of bass section 1100.

Such an arrangement of a driver within an enclosure is known in the electro-acoustic arts as a ported bass trap enclosure. Although in the embodiment shown in the figures a ported bass trap is shown, there are further embodiments of the present disclosure wherein the enclosure and driver are arrange in a ported, sealed, transmission line, or ported band-pass configuration.

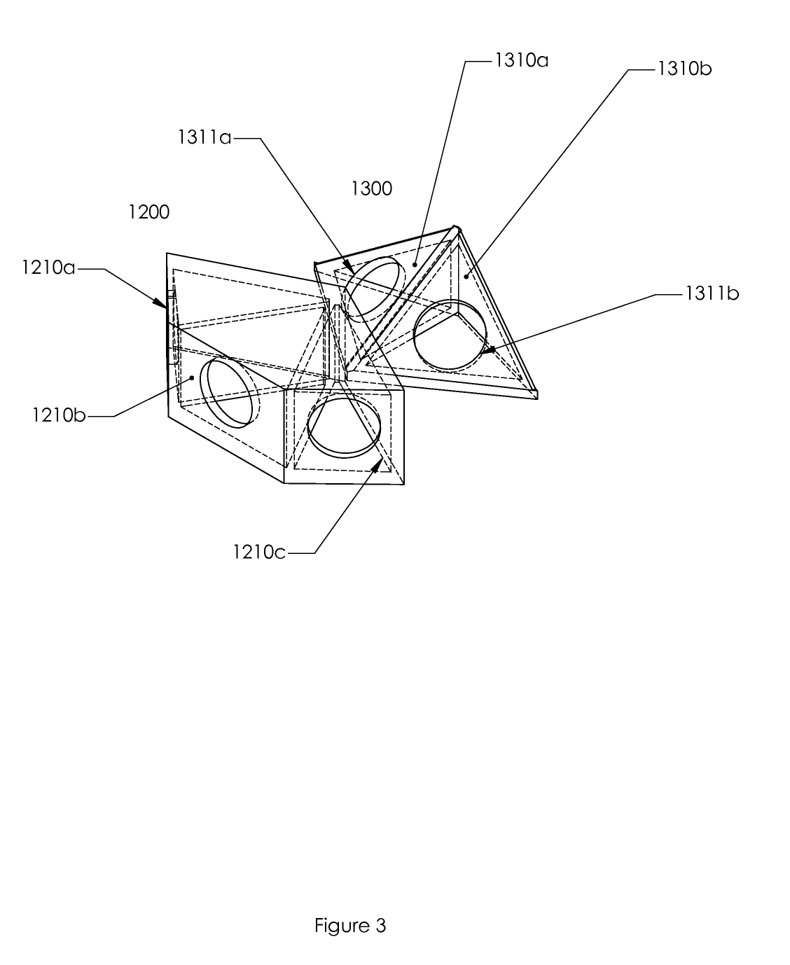

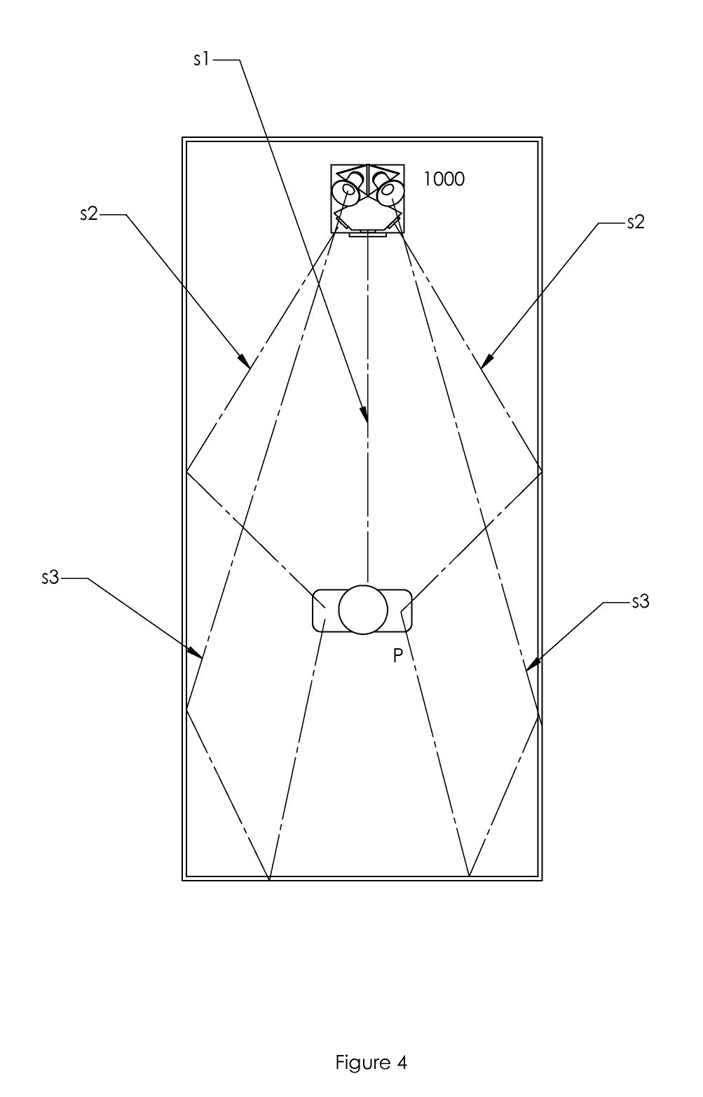

With reference to FIG. 3, a direct section 1200 and reflecting section 1300 are shown. Direct section 1200 is comprised of three volumes, 1210(a-c), assuming that there is a listening axis X extending normally to the face of volume 1210(b), the anterior faces of volumes 1210(a and c) are oriented at an angle Θ1 to X with Θ1 being in the range of 4-40 degrees.

There are apertures 1211(a-c) disposed upon respective faces 1210(a-c) configured to retain electromagnetic acoustic drivers therein. According the embodiment of the resent disclosure shown in the figures, each aperture 1211(a-c) leads to a sealed volume tuned to a given frequency F according to sealed enclosure equations known in the acoustic arts. Although the enclosure is shown as sealed, there are further embodiments of the present disclosure, wherein the faces 1210(a-c) may be arranged in open baffle, ported, or transmission line enclosures.

With continued reference to FIG. 3, a reflecting section 1300 has to faces 1310(a and b) disposed thereupon. Faces 1310(a and b) are oriented at an angle Θ2 horizontally from X and Θ3 from the sagittal plane of sound system 1000. Θ2 is in the range from 4-40 degrees. Θ3 is in the range from 4-40 degrees.

There are apertures 1311(a and b) disposed upon respective faces 1330(a and b) configured to retain electromagnetic acoustic drivers therein. According the embodiment of the resent disclosure shown in the figures, each aperture 1311(a and b) leads to a sealed volume tuned to a given frequency F according to sealed enclosure equations known in the acoustic arts. Although the enclosure is shown as sealed, there are further embodiments of the present disclosure, wherein the faces 1310(a and b) may be arranged in open baffle, ported, or transmission line enclosures.

With returning reference to FIG. 1, there are two wave-guides 1320(a and b) disposed upon apertures 1311(a and b). Wave-guides 1320(a and b) are configured to prevent direct sound from the drivers disposed within apertures 1311(a and b) from reaching the listener. Instead, Θ2, Θ3, and waveguides 1320(a and b) direct the majority of the sound emitting from those drivers toward the ceiling and walls of the room in which the device is disclosed.

In such an arrangement, sound from the drivers disposed within direct section 1200 arrive at a listener in a direct manner while sound from drivers disposed within reflecting section 1300 reach a listener in a reflecting manner.

A method of using sound system 1000 will now be described. In a first configuration of sound system 1000, the system is oriented within a rectangular room having four walls at normal angles to one another as well as a with a floor and ceiling oriented in substantially parallel relation to one another. Sound system 1000 is connected to a multi-channel surround audio-video receiver such that the drivers disposed upon faces 1210(a, b, c) are connected to the respective right-main, center-channel, and left-main outputs. Similarly, the drivers disposed upon faces 1310(a and b) are connected to respective rear-right effect and rear-left effect output. The driver disposed within bass section 1100 is connected to the low frequency effect output.

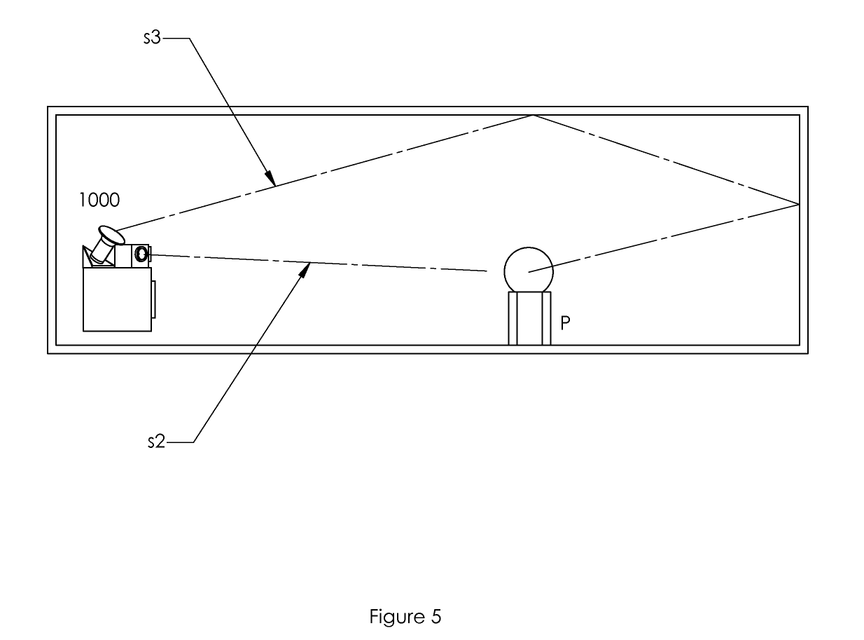

Referring now to FIG. 4, a ray diagram is shown wherein the paths which sound from the respective electro-acoustic drivers of a sound system 1000 reach a listener P are denoted by interrupted lines. Ray s1 projects directly from the center channel to the listener without substantially interfering with the walls.

Rays s2 and s4 project from the front left and right channels. Among these, s4 reach the listener without substantial interference from the walls while s2 reach the listener with substantial interference from the walls. The combination of direct and reflected sound simulates sound coming from the respective left and right sides of the listener.

Conversely, rays s3 project from the right and left rear effect channels. Because of the presence of the wave-guides about the drivers, minimal sound from these reaches the listener in a direct manner, thus simulating the presence of rear speakers.

Within the scope of this document, the following terms shall have their accepted meanings in the sound reproduction arts, which are described briefly herein. “Full Range” drivers are electro-acoustic systems which convert electrical energy to acoustic energy over a broader range of wavelengths than traditional single-purpose drivers such as tweeters, woofers, etc. Two illustrative examples of “full-range” drivers include for instance the Tang Band W3-1364 SA and the Mark Audio Alpair 7.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A sound system for use in an enclosed room having a listening position disposed therein comprising;
an electro-acoustic driver mounted upon a first surface A, wherein ray X, extending in an orthogonal relation from the face of A can reach the listening position without substantial interference from a wall, floor, or ceiling thereby defining a direct configuration;
an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling thereby defining a reflecting configuration.

2. The sound system of claim 1, wherein the drivers are full range drivers.

3. The sound system of claim 1, wherein each driver is arranged in a woofer and tweeter configuration.

4. The sound system of claim 3, wherein the exits of both the tweeter and woofer are disposed substantially within the waveguide.

5. The sound system of claim 3, wherein the exit of the high frequency driver is disposed substantially within the waveguide.

6. The sound system of claim 1, wherein there is a plurality of drivers disposed within the enclosure and divided into two sets, with the first set configured in a direct configuration, and a second set configured in a reflecting configuration.

7. The sound system of claim 6, first set comprises a left-facing driver disposed at a lateral angle θ1 from the saggital plane, a center-facing driver in substantial alignment with the saggital plane, and a right-facing driver disposed at a lateral angle—θ1 from the saggital plane wherein θ1 is between 4 and 40 degrees.

8. The sound system of claim 6, wherein the second set comprises a left-facing speaker disposed at a lateral angle θ2 from the saggital plane and a cephalic angle θ3 from the traverse plane and right-facing speaker at a lateral angle—θ2 from the saggital plane and a cephalic angle θ3 from the traverse plane wherein θ2 and θ3 are each between 15 and 85 degrees.

9. The sound system of claim 1, wherein there is a low frequency driver and enclosure disposed caudally from the direct and reflecting drivers.

10. The sound system of claim 8, wherein the low frequency driver is enclosed in a box having a configuration selected from ported, sealed, bass trap, or transmission line and tune to a frequency between 20 Hz and 600 Hz.

11. The sound system of claim 1, wherein the wave-guide is a constant-directivity horn.

12. The sound system of claim 1, wherein the wave-guide is oblate sphericoid in shape.

13. The sound system of claim 1, wherein the wave-guide is a circular horn tuned predominantly to a frequency between 100 Hz and 20,000 Hz.

14. The sound system of claim 1, wherein the, wave-guide is an elliptical horn tuned predominantly to a frequency between 100 Hz and 20,000 Hz.

15. The sound system of claim 1, wherein the wave-guide is an angular horn tuned predominantly to a frequency between 100 Hz and 20,000 Hz.

16. The sound system of claim 1, wherein the wave-guide encloses the entire circumference of its corresponding driver.

17. The sound system of claim 1, wave-guide encloses a portion of the circumference of its corresponding driver.

18. A sound system for use in an enclosed room having a listening position disposed therein comprising;
an electro-acoustic driver mounted upon a first surface A, wherein ray X, extending in an orthogonal relation from the face of A can reach the listening position without substantial interference from a wall, floor, or ceiling;
an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling;
wherein the drivers are full range speakers and the waveguide is a horn tuned to a frequency between 100 Hz and 20,000 Hz.

19. A sound system for use in an enclosed room having a listening position disposed therein comprising;
an electro-acoustic driver mounted upon a first surface A, wherein ray X, extending in an orthogonal relation from the face of A can reach the listening position without substantial interference from a wall, floor, or ceiling;
an electro-acoustic driver mounted within a partially enclosed waveguide mounted upon a second surface B, wherein ray Y, extending in an orthogonal relation from the face of B is displace between 4 and 40 degrees from ray X in any direction such that Y can reach the listening position only after substantial interference from a wall, floor, or ceiling.
